(19) United States
(12) Patent Application Publication
(10) Pub. No.: US 2016/0319185 A1
(43) Pub. Date: Nov. 3, 2016

(54) SHEAR THICKENING FLUID METHOD AND SYSTEM TO DELIVER MATERIALS DOWNHOLE

(71) Applicant: SCHLUMBERGER TECHNOLOGY CORPORATION, Suger land, TX (US)

(72) Inventors: Sergey Vladimirovich Semenov, Kurgan (RU); Sergey Makarychev-Mikhailov, Richmond, TX (US); Mohan Kanaka Raju Panga, Sugar Land, TX (US)

(21) Appl. No.: 15/106,066

(22) PCT Filed: Dec. 18, 2013
(86) PCT No.: PCT/RU2013/001131

§ 371 Date: Jun. 17, 2016

(51) Int. Cl. C09K 8/68; C09K 8/90; E21B 33/14; E21B 43/26; E21B 43/04; C09K 8/80; E21B 43/267

(52) U.S. Cl. CPC C09K 8/68; C09K 8/80; C09K 8/90; E21B 43/267; E21B 43/26; E21B 43/04; E21B 33/14; C09K 2208/08

(57) ABSTRACT

A method and system for delivering materials downhole employing a shear thickening treatment fluid. The viscosity of the shear thickening treatment fluid increases with increasing shear rate. The shear thickening fluid may inhibit particulate dispersion, settling or a combination thereof at high shear rates and facilitate dispersion and/or settling of the particulates and/or formation of pillars or clusters in the fracture at low shear rates.

### RELATED APPLICATION DATA

None.

### BACKGROUND

The statements in this section merely provide background information related to the present disclosure and may not constitute prior art.

Fracturing is used to create conductive pathways in a subterranean formation and increase fluid flow between the formation and the wellbore. A fracturing fluid is injected into the wellbore passing through the subterranean formation. A propping agent (proppant) is injected into the fracture to prevent fracture closure and, thereby, to provide improved extraction of extractive fluids, such as oil, gas or water.

The proppant maintains the distance between the fracture walls in order to create conductive channels in the formation. The pulsed injection of alternating proppant-free and proppant-laden slugs into the fracture has been used to obtain a heterogeneous distribution of proppant particles into a channels and pillars configuration, which can improve the conductivity in the fracture. Accordingly, there is a demand for further improvements in this area of technology.

### SUMMARY

In some embodiments according to the disclosure herein, a method and system are provided for increasing fracture conductivity employing a shear thickening treatment fluid in one or more treatment stages or substages, e.g., in the context of heterogeneous proppant placement wherein conductive channels are formed around pillars corresponding to proppant clusters placed in the fracture.

### BRIEF DESCRIPTION OF THE DRAWINGS

These and other features and advantages will be better understood by reference to the following detailed description when considered in conjunction with the accompanying drawings.

FIG. 1 is a schematic diagram of a wellbore section supplying a treatment stage of alternated pillar-forming and channel-forming substages wherein the pillar-forming substages are capped by and/or comprised of a shear thickening fluid according to some embodiments of the current application.

FIG. 2 is a schematic diagram of a wellbore section supplying a treatment stage of alternated pillar-forming and channel-forming substages wherein the pillar-forming and/or channel-forming substages are capped by and/or comprised of a shear thickening fluid according to some embodiments of the current application.

FIG. 3 is a schematic diagram of a wellbore section supplying a treatment stage of alternated pillar-forming and channel-forming substages and including PAD and/or tail substages comprised of a shear thickening fluid according to some embodiments of the current application.

FIG. 4 is a schematic diagram of clusters formed in a fracture to maintain a system of interconnected hydraulically conductive channels for reservoir fluid production according to some embodiments of the current application.

FIG. 5 is a schematic diagram of the fracture of FIG. 4 following closure according to some embodiments of the current application.

FIG. 6 shows a plot of the storage and loss moduli over an angular frequency from 0.1 to 100 s⁻¹ at fixed amplitude for the 20wt % mixture of aqueous pregelatinized starch of Example 1 according to some embodiments of the current application.

### DETAILED DESCRIPTION OF SOME ILLUSTRATIVE EMBODIMENTS

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the instant disclosure.

In some embodiments according to the disclosure herein, a method for treating a subterranean formation penetrated by a wellbore, comprises injecting into the wellbore a shear thickening treatment fluid comprising a slurry of particulates distributed therein; following the injection into the wellbore, transitioning the shear thickening treatment fluid, from a first flow regime with a relatively moderate shear rate from 10 up to 100 s⁻¹, to a second flow regime with a higher shear rate relative to the moderate shear rate of the first flow regime, wherein the viscosity of the shear thickening treatment fluid increases with increasing shear rate in the second flow regime to inhibit dispersion and/or settling of the particulates; and transitioning the shear thickening treatment fluid from the second flow regime to a third flow regime with a lower shear rate relative to the moderate shear rate of the first flow regime, to promote dispersion and/or settling of at least some of the particulates.

As used herein, the term “particulates” refers to solid, non-colloidal particles, e.g., particles having a particle size of at least 1 micron.

In some embodiments according to the disclosure herein, the particulates comprise proppant and/or the second and third flow regimes occur in a fracture. In some embodiments according to the disclosure herein, the proppant is heterogeneously placed to form spaced-apart clusters in the fracture, and/or the method further comprises reducing pressure in the fracture to prop the fracture open on the clusters and form interconnected, hydraulically conductive channels between the clusters.

In some embodiments according to the disclosure herein, a method to treat a subterranean formation penetrated by a wellbore, comprises: supplying to the wellbore a treatment stage comprising a plurality of pillar-forming substages alternated between channel-forming substages and including at least one substage comprising a shear thickening treatment fluid; injecting the treatment stage into the formation above a fracturing pressure to form a fracture; forming pillars in the fracture spaced apart by channels corresponding to the respective pillar-forming and channel-forming substages; reducing pressure in the fracture to prop the fracture open on the pillars and form an interconnected, hydraulically conductive network of the channels between the clusters; and transitioning the shear thickening treatment fluid between a relatively low viscosity flow regime and a high viscosity flow regime.

In some embodiments according to the disclosure herein, the transitioning of the shear thickening treatment fluid between the relatively low viscosity flow regime and the high viscosity flow regime comprises increasing a shear rate applied to the shear thickening treatment fluid from less than 100 s⁻¹ in the first flow regime, e.g., less than 50 s⁻¹ or less than 20 s⁻¹, to greater than 100 s⁻¹ in the second flow regime, e.g., greater than 200 s⁻¹, or greater than 300 s¹, or in a range of 300-500 s⁻¹. In some embodiments, the first flow regime is in the wellbore and the second flow regime is in the fracture during fracture creation and/or propagation. In some embodiments according to the disclosure herein, the pillar-forming substages comprise a proppant-laden treatment fluid and/or the channel-forming substages comprise a proppant-lean treatment fluid. In some embodiments according to the disclosure herein, the proppant-laden treatment fluid comprises the shear thickening fluid, and/or the proppant-lean treatment fluid comprises the shear thickening fluid.

In some embodiments according to the disclosure herein, spacer substages are present between the pillar-forming substages and the channel-forming substages, and/or the spacer stages comprise fiber, the shear thickening treatment fluid, or a combination thereof.

In some embodiments according to the disclosure herein, a method to treat a subterranean formation penetrated by a wellbore, comprises: supplying to the wellbore a treatment stage comprising a plurality of proppant-laden substages alternated between proppant-lean substages and including at least one substage comprising a shear thickening treatment fluid; injecting the treatment stage into the formation above a fracturing pressure to form a fracture; transitioning the shear thickening treatment fluid, from a first flow regime with a relatively moderate shear rate in the wellbore, to a second flow regime in the fracture with a higher shear rate relative to the moderate shear rate of the first flow regime, wherein the viscosity of the shear thickening treatment fluid increases with increasing shear rate in the second flow regime, e.g., beginning at a shear rate less than 1000 s⁻¹, to inhibit dispersion and/or settling of the proppant and distribute the proppant into the fracture; transitioning the shear thickening treatment fluid from the second flow regime to a third flow regime in the fracture with a lower shear rate relative to the shear rate of the first flow regime, to promote dispersion and/or settling of proppant from the proppant-laden substage and/or formation of spaced-apart clusters in the fracture; and reducing pressure in the fracture to prop the fracture open on the clusters and form an interconnected, hydraulically conductive network of channels between the clusters.

In some embodiments according to the disclosure herein, the proppant-laden substages comprise the shear thickening fluid, and/or the proppant-lean substages comprise the shear thickening fluid. In some embodiments according to the disclosure herein, spacer substages are disposed between the proppant-laden substages and the proppant-lean substages, and/or the spacer stages comprise fiber, the shear thickening treatment fluid, or a combination thereof.

In some embodiments according to the disclosure herein, a method to treat a subterranean formation penetrated by a wellbore, comprises: supplying a treatment stage to the wellbore, wherein the treatment stage comprises a plurality of pillar-forming substages alternated between channel-forming substages and including at least one substage comprising a shear thickening treatment fluid; injecting the treatment stage into the formation above a fracturing pressure to form a fracture; forming pillars in the fracture spaced apart by channels corresponding to the respective pillar-forming and channel-forming substages; reducing pressure in the fracture to prop the fracture open on the pillars and form an interconnected, hydraulically conductive network of the channels between the clusters; and transitioning the shear thickening treatment fluid between low and high shear rate flow regimes respectively below and above 100 s⁻¹. The steps of the method are not necessarily confined to any particular order, e.g., transitioning the shear thickening treatment fluid between low and high shear rate flow regimes respectively below and above 100 s⁻¹ may occur in transit between wellbore and the fracture and/or between fracture propagation and closure.

In some embodiments, a system to produce reservoir fluids comprises the wellbore and fracture resulting from any of the fracturing methods disclosed herein.

In some embodiments according to the disclosure herein, a system comprises: a subterranean formation penetrated by a wellbore; a treatment slurry stage disposed in the wellbore, the treatment slurry stage comprising a plurality of pillar-forming substages alternated between channel-forming substages and including at least one substage comprising a shear thickening treatment fluid; and a pump system to continuously deliver the treatment slurry stage from the wellbore to the formation at a pressure above fracturing pressure to inject the treatment fluid stage into a fracture in the formation. In some embodiments according to the disclosure herein, the pillar-forming substages comprise a proppant-laden treatment fluid and the channel-forming substages comprise a proppant-lean treatment fluid. In some embodiments according to the disclosure herein, the pillar-forming substages comprise the shear thickening fluid and the channel-forming substages are Newtonian, and/or the channel-forming substages comprise the shear thickening fluid and the proppant-forming substages are Newtonian. As used herein, a Newtonian fluid is one having a viscosity which does not vary over the applicable shear rates and durations by more than plus or minus 5% of the initial viscosity (t=0) at a shear rate of 170 s⁻¹, whereas a non-Newtonian fluid has a viscosity that changes by 5% or more relative to the initial viscosity at a shear rate of 170 s⁻¹.

In some embodiments according to the disclosure herein, the system further comprises spacer substages between the pillar-forming substages and the channel-forming substages, and/or the spacer stages comprise fiber, the shear thickening treatment fluid, or a combination thereof. In some embodiments according to the disclosure herein, the shear thickening treatment fluid is non-Newtonian, i.e., exhibits shear thickening behavior, over at least a portion of a range of shear rates from 100 s⁻¹ to 1000 s⁻¹, e.g., the shear thickening treatment fluid exhibits shear thickening at all shear rates, or has a transition shear rate between non-shear thickening and shear thickening flow regimes at either less than 100 s⁻¹, or greater than 100 s⁻¹ and less than 1000 s⁻¹, wherein the shear thickening treatment fluid exhibits Newtonian behavior below the transition shear rate and shear thickening behavior above the transition shear rate. In some embodiments according to the disclosure herein, the system further comprises a treatment fluid supply unit to supply the pillar-forming substages and the channel-forming substages to the wellbore.

In some embodiments according to the disclosure herein, a system to treat a subterranean formation penetrated by a wellbore, comprises: a pump system to deliver a treatment stage fluid through the wellbore to the formation above a fracturing pressure to form a fracture in the formation; a treatment stage fluid supply unit to supply the treatment stage fluid to the pump system, the treatment stage fluid comprising a plurality of proppant-laden substages alternated between proppant-lean substages and including at least one substage comprising a shear thickening treatment fluid to inhibit dispersion of proppant-laden substages, proppant settling or a combination thereof, during flow of the shear thickening treatment fluid and facilitate dispersion of proppant-laden substages, proppant settling or a combination thereof, during low-flow conditions; a shut-in system to terminate delivery of the treatment stage fluid into the fracture, to maintain pressure in the fracture at the low-flow condition to form pillars spaced apart by channels, and to then reduce the pressure in the fracture to prop the fracture open on the pillars and form interconnected, hydraulically conductive network of the channels between the pillars. In some embodiments according to the disclosure herein, one or more or all of the proppant-laden substages comprise the shear thickening fluid and one or more or all of the proppant-lean substages are Newtonian; and/or one or more or all of the proppant-lean substages comprise the shear thickening fluid and one or more or all of the proppant-laden substages are Newtonian.

In some embodiments according to the disclosure herein, the system further comprises spacer substages between the proppant-laden substages and the proppant-lean substages, wherein the spacer stages comprise fiber, the shear thickening treatment fluid, or a combination thereof. In some embodiments according to the disclosure herein, the shear thickening treatment fluid exhibits shear thickening behavior over at least a portion of a range of shear rates from 100 s⁻¹ to 1000 s⁻¹, e.g., the shear thickening treatment fluid exhibits shear thickening at all shear rates, or has a transition shear rate between non-shear thickening and shear thickening flow regimes at either less than 100 s⁻¹, or greater than 100 s⁻¹ and less than 1000 s^{-I}, wherein the shear thickening treatment fluid exhibits Newtonian behavior below the transition shear rate and shear thickening behavior above the transition shear rate.

In some embodiments according to the disclosure herein, a system to treat a subterranean formation penetrated by a wellbore, comprises: a treatment stage comprising a plurality of pillar-forming substages alternated between channel-forming substages and including at least one substage comprising a shear thickening treatment fluid; means for supplying the treatment stage to the wellbore; means for injecting the treatment stage into the formation above a fracturing pressure to form a fracture; means for forming pillars in the fracture spaced apart by channels corresponding to the respective pillar-forming and channel-forming substages; means for reducing pressure in the fracture to prop the fracture open on the pillars and form an interconnected, hydraulically conductive network of the channels between the clusters; and means for transitioning the shear thickening treatment fluid between shear thickening and non-shear thickening flow regimes.

In some embodiments according to the disclosure herein, a method and system are provided for increasing fracture conductivity employing a shear thickening fluid. By “shear thickening fluid” is meant that the fluid has an increasing viscosity when dynamically sheared or stressed, e.g., a dilatant or rheopectic fluid, which is normally but not necessarily reversible when the shear or stress condition is relaxed. A dilantant shear thickening fluid has a viscosity that increases with increasing shear rate, whereas a rheopectic shear thickening fluid has a viscosity that increases with the duration of an applied shear stress. Shear thickening fluids include, as an example, but are not limited to, colloidal dispersions of fine particles inside the liquid. As used herein, “fine particles” have a size less than 1 micron. According to some embodiments, the fine particles can be organic, e.g., cornstarch, latex particles, polyethylene oxide, or inorganic, e.g. silica. According to some embodiments, examples of shear thickening fluids include: a mixture of polyethylene oxide and petroleum sulfonate; gypsum pastes; colloidal silica particle dispersions (mean diameter≈450 nm); colloidal latex dispersions; polyethylene glycol solutions; starch slurries; and the like. The fine particles can also be of different shapes, which may also influence the rheological behavior of the mixture, e.g., the shear thickening imparted by different shapes of the fine particles over a range of shear rates from 100 to 300 s⁻¹ is generally rods>plates>grains>spheres. In some embodiments, the fine particles are present in sufficient quantity so as to impart shear thickening behavior to the fluid.

According to some embodiments herein, enhanced delivery of material downhole may be used in a variety of oilfield applications including but not limited to well stimulation and fluid loss control applications. According to some embodiments, the method uses a shear thickening fluid as a fluid for pumping materials downhole in the oil or gas well. According to some embodiments, material can represent proppant, proppant agglomerates, fibers, etc., e.g., to transport proppant slugs as the main treatment fluid and/or as an auxiliary consolidating fluid, as in cap, spacer and/or intermediate substages before and/or after each proppant slug.

Fluid movement increases the applied shear rate, therefore shear thickening fluids increase their viscosity while being pumped through the wellbore, and in some embodiments increase further when transported inside the fracture where the shear rate is typically even higher than in the wellbore. Increased apparent viscosity facilitates inhibiting dispersion of the proppant or other particulates into adjacent fluids. When the material in the shear thickening fluid reaches its destination the fluid movement can be stopped, decreasing the applied shear rate and therefore decreasing the apparent viscosity, leading to release of the delivered material and further to possible leakoff of the shear thickening fluid to the formation matrix. For example, in fluid loss control applications the fluid loss control agent may be held in the fluid during transport and placement, and once in position, released by stopping the fluid flow to allow the fluid loss control agent to settle out of the fluid.

In some embodiments of the present disclosure, the shear thickening fluid may be used in a technique of heterogeneous proppant placement (HPP) for oil and gas well stimulation, for example, such as in the HiWAY process developed by Schlumberger Technology Corporation. In some HPP embodiments, the shear thickening fluid may be employed as a dispersion inhibitor and/or carrier fluid to inhibit dispersion of proppant-laden pulses inside the surface lines, inside the wellbore, and/or inside the fracture. When the material in the shear thickening fluid reaches its destination in the HPP process, stopping the fluid movement reduces the applied shear rate and therefore decreases the apparent viscosity, leading to release of the proppant and/or other delivered material and formation of proppant clusters which may become pillars to prop the fracture open upon closure and form hydraulically conductive channels around and/or between the pillars for reservoir fluid to be produced to the wellbore.

As used herein, a “hydraulically conductive fracture” is one which has a high conductivity relative to the adjacent formation matrix, whereas the term “conductive channel” refers to both open channels as well as channels filled with a matrix having interstitial spaces for permeation of fluids through the channel, such that the channel has a relatively higher conductivity than adjacent non-channel areas.

In embodiments, the conductive channels are formed after placement of the proppant particles in the fracture by differential placement of the proppant particles, e.g., by alternating proppant-laden and proppant-lean substages, and/or by differential movement of the proppant particles after placement in the fracture, e.g., by gravitational settling and/or fluid movement such as fluid flow initiated by a flowback operation, out of and/or away from an area(s) corresponding to the conductive channel(s) and into or toward spaced-apart areas in which clustering of the proppant particles results in the formation of relatively less conductive areas, which clusters may correspond to pillars between opposing fracture faces upon closure.

In some embodiments, the method comprises triggering dispersion and/or settling of the proppant or other solid particulate, e.g., after placement in the fracture. In some embodiments, the method further comprises viscosifying the treatment stage fluid for introducing the proppant or other particulate into the formation, and breaking the treatment stage fluid in the fracture to trigger the dispersion and/or settling. In some embodiments, the triggering may comprise relaxing the shear or stress on the shear thickening fluid. In some embodiments, the method further comprises successively alternating concentration modes of proppant or other additive in the treatment stage fluid between a relatively proppant-rich mode and a proppant-lean mode during the distribution into the formation in the treatment stage fluid to facilitate one or both of the cluster formation and/or channel formation. As used herein, a pillar-forming stage or substage is or becomes a proppant-laden treatment fluid and/or a stage or substage containing an additive which induces or facilitates agglomeration of the proppant or other solid particulates into clusters within the stage or substage, whereas a channel-forming stage or substage is or becomes a proppant-lean treatment fluid and/or a stage or substage containing an additive which induces or facilitates agglomeration of the proppant or other solid particulates into clusters in an adjacent stage or substage, e.g., in a pillar-forming stage. A proppant- or particulate-lean mode is essentially free of proppant or particulate if the concentration of proppant or particulate is insufficient to form clusters and/or pillars.

In some embodiments, the conductive channels extend in fluid communication from adjacent a face of in the formation away from the wellbore to or to near the wellbore, e.g., to facilitate the passage of fluid between the wellbore and the formation, such as in the production of reservoir fluids and/or the injection of fluids into the formation matrix. As used herein, “near the wellbore” refers to conductive channels coextensive along a majority of a length of the fracture terminating at a permeable matrix between the conductive channels and the wellbore, e.g., where the region of the fracture adjacent the wellbore is filled with a permeable solids pack as in a high conductive proppant tail-in stage, gravel packing or the like.

In some embodiments, a method for treating a subterranean formation penetrated by a wellbore comprises: injecting into a fracture in the formation at a continuous rate a treatment fluid stage; while maintaining the continuous rate, successively alternating concentration modes of proppant or other particulate, such as fiber, in the treatment fluid stage between a plurality of relatively proppant-rich modes and a plurality of proppant-lean modes within the injected treatment fluid stage.

In some embodiments, the injection of the treatment fluid stage forms heterogeneous areas within the fracture comprising proppant-rich areas and proppant-lean areas.

In some embodiments, the injected treatment fluid stage comprises a viscosified carrier fluid, and the method may further comprise reducing the viscosity of the carrier fluid in the fracture to induce dispersion and/or settling of the proppant or other solid particulate prior to closure of the fracture, and thereafter allowing the fracture to close. In some embodiments, the viscosified treatment fluid comprises a shear thickening fluid and the viscosity is reduced by reducing the shear rate or stress on the viscosified treatment fluid, e.g., by inducing a low-flow or no flow condition. As used herein a low-flow condition is one in which the shear rate is less than 1 s⁻¹.

In some embodiments, the method may also include forming clusters or pillars with the proppant-rich modes in the fracture and forming conductive channels between the clusters or pillars with the proppant-lean modes.

In some embodiments, the method may include transforming the pillar-forming substages into nodes rich in the proppant or other particulate to form the pillars. In some embodiments, the pillar-forming and channel-forming substages may have different characteristics to impart different settling rates. In some embodiments, the proppant or other particulate in the pillar-forming and channel forming substages may have different shapes, sizes, densities or a combination thereof. In some embodiments, the proppant or other particulate may have an aspect ratio, defined as the ratio of the longest dimension of the particle to the shortest dimension of the particle, higher than 6. In some embodiments, the proppant or other particulate in the pillar-forming and/or channel forming substages is a fiber, a floc, a flake, a ribbon, a platelet, a rod, or a combination thereof.

In some embodiments, the proppant or other particulate in the pillar-forming and/or channel forming substages may comprise a degradable material. In some embodiments, the proppant or other particulate in the pillar-forming and/or channel forming substages is selected from the group consisting of polylactic acid (PLA), polyglycolic acid (PGA), polyethylene terephthalate (PET), polyester, polyamide, polycaprolactam and polylactone, poly(butylene succinate), polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, or other natural fibers, rubber, sticky fiber, or a combination thereof. In some embodiments the particulates/proppants may comprise acrylic fiber. In some embodiments the particulates/proppants may comprise mica.

In some embodiments, the proppant or other particulate is present in the proppant-laden stages of the treatment slurry in an amount of less than 5 vol %. All individual values and subranges from less than 5 vol % are included and disclosed herein. For example, the amount of proppant may be from 0.05 vol % less than 5 vol %, or less than 1 vol %, or less than 0.5 vol %. The proppant or other particulate may be present in an amount from 0.5 vol % to 1.5 vol %, or in an amount from 0.01 vol % to 0.5 vol %, or in an amount from 0.05 vol % to 0.5 vol %.

In further embodiments, the proppant or other particulate may comprise a fiber with a length from 1 to 50 mm, or more specifically from 1 to 10 mm, and a diameter of from 1 to 50 microns, or, more specifically from 1 to 20 microns. All values and subranges from 1 to 50 mm are included and disclosed herein. For example, the fiber length may be from a lower limit of 1, 3, 5, 7, 9, 19, 29 or 49 mm to any higher upper limit of 2, 4, 6, 8, 10, 20, 30 or 50 mm. The fiber length may range from 1 to 50 mm, or from 1 to 10 mm, or from 1 to 7 mm, or from 3 to 10 mm, or from 2 to 8 mm. All values from 1 to 50 microns are included and disclosed herein. For example, the fiber diameter may be from a lower limit of 1, 4, 8, 12, 16, 20, 30, 40, or 49 microns to an upper limit of 2, 6, 10, 14, 17, 22, 32, 42 or 50 microns. The fiber diameter may range from 1 to 50 microns, or from 10 to 50 microns, or from 1 to 15 microns, or from 2 to 17 microns.

In further embodiments, the fiber may be selected from the group consisting of polylactic acid (PLA), polyester, polycaprolactam, polyamide, polyglycolic acid, polyterephthalate, cellulose, wool, basalt, glass, rubber, or a combination thereof.

In further embodiments, the fiber may comprise a length from 0.001 to 1 mm and a diameter of from 50 nanometers (nm) to 10 microns. All individual values from 0.001 to 1 mm are disclosed and included herein. For example, the fiber length may be from a lower limit of 0.001, 0.01, 0.1 or 0.9 mm to any higher upper limit of 0.009, 0.07, 0.5 or 1 mm. All individual values from 50 nanometers to 10 microns are included and disclosed herein. For example, the fiber diameter may range from a lower limit of 50, 60, 70, 80, 90, 100, or 500 nanometers to an upper limit of 500 nanometers, 1 micron, or 10 microns.

In some embodiments, the proppant or other particulate may comprise an expandable material, such as, for example, swellable elastomers, temperature expandable particles. Examples of oil swellable elastomers include butadiene based polymers and copolymers such as styrene butadiene rubber (SBR), styrene butadiene block copolymers, styrene isoprene copolymer, acrylate elastomers, neoprene elastomers, nitrile elastomers, vinyl acetate copolymers and blends of EV A, and polyurethane elastomers. Examples of water and brine swellable elastomers include maleic acid grafted styrene butadiene elastomers and acrylic acid grafted elastomers. Examples of temperature expandable particles include metals and gas filled particles that expand more when the particles are heated relative to silica sand. In some embodiments, the expandable metals can include a metal oxide of Ca, Mn, Ni, Fe, etc. that reacts with the water to generate a metal hydroxide which has a lower density than the metal oxide, i.e., the metal hydroxide occupies more volume than the metal oxide thereby increasing the volume occupied by the particle. Further examples of swellable inorganic materials can be found in U.S. Application Publication Number US 2011/0098202, which is hereby incorporated by reference in its entirety. An example for gas filled material is EXPANCEL™ microspheres that are manufactured by and commercially available from Akzo Nobel of Chicago, Ill. These microspheres contain a polymer shell with gas entrapped inside. When these microspheres are heated the gas inside the shell expands and increases the size of the particle. The diameter of the particle can increase 4 times which could result in a volume increase by a factor of 64.

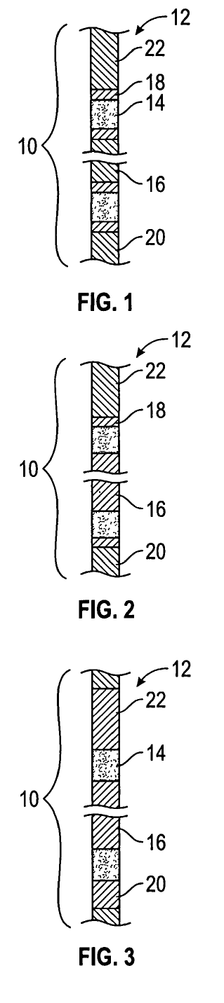

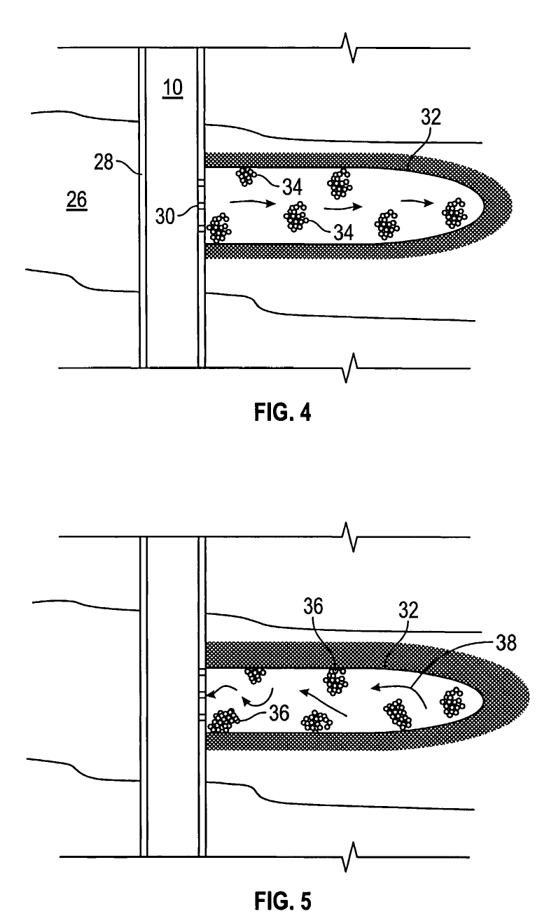

In some embodiments, the method comprises pumping a treatment stage fluid through a wellbore, wherein the treatment stage fluid comprises a plurality of pillar-forming substages alternated between channel-forming substages and including at least one substage comprising a shear thickening treatment fluid. With reference to FIG. 1, in some embodiments the treatment stage fluid 10 is pumped down the wellbore 12 in a plurality of pillar-forming slugs 14 alternated with channel-forming slugs 16, which may be separated by optional spacer substages 18. In some embodiments, the pillar-forming slugs 14 may comprise particulates such as proppant or other solids, and may optionally comprise a shear thickening fluid as the carrier fluid. The pillar-forming slugs 14 function as the pillar-forming substages wherein the particulates carried in the treatment stage fluid, e.g., proppant carried in the pillar-forming slugs 14 or otherwise in the treatment fluid, form proppant clusters which ultimately form the pillars (see FIGS. 4-5) to hold open the fracture and allow the production of reservoir fluids through a network of conductive channels formed through the spaces between the pillars. The channel-forming slugs 16 may optionally be lean in proppant and/or have a composition that imparts a different settling rate so that conductive channels are formed generally corresponding to the placement of the slugs 16 within the fracture and/or otherwise in the formation.

If desired, in some embodiments, the pillar-forming slugs 14 and the channel-forming slugs 16 may be separated by spacer slugs 18. In some embodiments, spacer slugs 18 may comprise fiber, a relatively high viscosity carrier fluid and/or a shear thickening fluid to inhibit dilution of the pillar-forming slugs 14, dilution of the channel-forming slugs 16, and/or mixing between the slugs 14, 16.

The treatment stage fluid 10 may in some embodiments also include an initial PAD substage 20 and/or final tail and/or flush substage 22, either or both of which may, if desired, be free of proppant and/or other particulates. The substages 20, 22 in some embodiments may be free of shear thickening carrier fluid, i.e., be selected from viscous fluids that are Newtonian at the shear rates and conditions existing in the wellbore 12 and/or the fracture.

According to some embodiments, FIG. 2 shows a treatment fluid stage 10 wherein the channel-forming (e.g., proppant-lean) slugs 16 comprise a shear thickening fluid and are disposed directly between the alternated pillar-forming (e.g., proppant-laden) slugs. According to these embodiments, the spacer slugs 18 between the pillar-forming slugs 14 and the channel-forming slugs 16 in FIG. 1 may be eliminated altogether, or subsumed by the channel forming slugs 16 which are compositionally indistinguishable. However, if desired, spacer slugs 18 may optionally be employed behind the PAD substage 20, which may be free of shear thickening properties, e.g., Newtonian or shear thinning, and/or in advance of the tail or flush substage 22, which may alternatively or additionally be free of shear thickening properties, e.g., Newtonian or shear thinning. This arrangement avoids any difficulties that might otherwise be seen with trying to meter a relatively small spacer slug 18 between the pillar-forming slugs 14 and the channel-forming slugs 16.

According to some embodiments, FIG. 3 shows a treatment fluid stage 10 wherein the channel-forming (e.g., proppant-lean) slugs 16 comprise a shear thickening fluid and are disposed directly between the alternated pillar-forming (e.g., proppant-laden) slugs as in FIG. 2, and also wherein the PAD substage 20 and/or the tail or flush substage 22 comprise a shear thickening fluid. According to these embodiments, the spacer slugs 18 after the PAD substage 20 and/or before the tail or flush substage 22 in FIG. 2 may be eliminated altogether, or subsumed by the adjacent pillar forming (e.g., proppant-laden) slug(s) 16 which are compositionally indistinguishable. This arrangement has the advantage of maintaining shear-thickened viscosity of the substages 20, 22 during transport down the wellbore 12 and/or into the fracture to more closely match the viscosity and/or proppant settling characteristics of the adjacent slug(s) 16 where this is desired.

FIGS. 4 and 5 illustrate some embodiments according to the present disclosure wherein proppant clusters are placed in the fracture (FIG. 4) and the fracture is allowed to close thereon (FIG. 5). A wellbore 10 is drilled through a subterranean zone 26 and may optionally, if desired, be cased with casing 28 which may be cemented in place. Perforations 30 are provided to establish entry points for the treatment fluid to enter the zone 26 from the wellbore 10. The treatment fluid may be pumped downhole at a rate and pressure sufficient to form a fracture 32.

The method and system of this disclosure facilitates the formation of proppant clusters 34, due to the alternating injection of pillar-forming and channel-forming substages, which may have, for example, different proppant contents, different settling characteristics, which may arise, for example, from different proppant transport capabilities, different pump rates, different carrier fluid densities and/or viscosities, different proppant diameters and/or densities, the presence/absence of fibers and/or high aspect ratio particles, and the like, or any combination of these. The proppant clusters 34 are spread out along a large fraction, e.g., most or all of the fracture length as shown in FIG. 4.

As a result, according to some embodiments, when the pressure is released, the clusters 34 form pillars 36, prevent the resulting fracture 32 shown in FIG. 5 from shrinking or closing completely, and form a network of hydraulically conductive channels 38 between the pillars 36 to facilitate formation fluid production to the wellbore 10.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, an energized fluid (including foam), slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein, in reference to a shear thickening fluid refers to the apparent dynamic viscosity of the fluid at its ambient conditions of temperature and shear rate, or in reference to a test fluid in general its apparent dynamic viscosity at reported test conditions, e.g., a temperature of 25° C. and shear rate of 170 s⁻¹ unless otherwise indicated. “Transitioning” between flow regimes refers to changes in viscosity of a shear thickening fluid, e.g., increasing or decreasing the viscosity by changing the applied shear rate from a first viscosity to a second viscosity, and may include passing through an interim flow regime in which the fluid temporarily has a higher viscosity than the highest of the first and second flow regimes and/or a lower viscosity than the lowest of the first and second flow regimes.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous gas or liquid fluid phases dispersed in the continuous phase, including any solutes, thickeners or colloidal particles only, exclusive of other solid phase particles; reference to “water” in the slurry refers only to water and excludes any gas, liquid or solid particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The term “dispersion” means a mixture of one substance dispersed in another substance, and may include colloidal or non-colloidal systems. As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

The terms “energized fluid” and “foam” refer to a fluid which when subjected to a low pressure environment liberates or releases gas from solution or dispersion, for example, a liquid containing dissolved gases. Foams or energized fluids are stable mixtures of gases and liquids that form a two-phase system. Foam and energized fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the term “energized fluid” also encompasses foams and refers to any stable mixture of gas and liquid, regardless of the foam quality. Energized fluids comprise any of:
(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry. The continuous fluid phase, also referred to herein as the carrier fluid or comprising the carrier fluid, may be any matter that is substantially continuous under a given condition. Examples of the continuous fluid phase include, but are not limited to, water, hydrocarbon, gas (e.g., nitrogen or methane), liquefied gas (e.g., propane, butane, or the like), etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. Some non-limiting examples of the fluid phase(s) include hydratable gels and mixtures of hydratable gels (e.g. gels containing polysaccharides such as guars and their derivatives, xanthan and diutan and their derivatives, hydratable cellulose derivatives such as hydroxyethylcellulose, carboxymethylcellulose and others, polyvinyl alcohol and its derivatives, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil.

The discontinuous phase if present in the treatment fluid may be any particles (including fluid droplets) that are suspended or otherwise dispersed in the continuous phase in a disjointed manner. In this respect, the discontinuous phase can also be referred to, collectively, as “particle” inclusive of solid “particulate” (as defined above). As used herein, the term “particle” should be construed broadly. For example, in some embodiments, the particle(s) of the current application are solid particulates such as proppant, sands, ceramics, crystals, salts, etc.; however, in some other embodiments, the particle(s) can be liquid, gas, foam, emulsified droplets, etc. Moreover, in some embodiments, the particle(s) of the current application are solid particulates that are substantially stable and do not change shape or form over an extended period of time, temperature, or pressure; in some other embodiments, the particle(s) of the current application are solid particulates that are degradable, expandable, swellable, dissolvable, deformable, meltable, sublimeable, or otherwise capable of being changed in shape, state, or structure.

In an embodiment, the solid particulate(s) is substantially round and spherical. In an embodiment, the solid particulate(s) is not substantially spherical and/or round, e.g., it can have varying degrees of sphericity and roundness, according to the API RP-60 sphericity and roundness index. For example, the solid particulate(s) may have an aspect ratio of more than 2, 3, 4, 5 or 6. Examples of such non-spherical solid particulates include, but are not limited to, fibers, flocs, flakes, discs, rods, stars, etc. All such variations should be considered within the scope of the current application.

Introducing high-aspect ratio particles into the treatment fluid, e.g., particles having an aspect ratio of at least 6, represents additional or alternative embodiments for stabilizing the treatment fluid and inhibiting settling during proppant placement, which can be removed, for example by dissolution or degradation into soluble degradation products. Examples of such non-spherical particles include, but are not limited to, fibers, flocs, flakes, discs, rods, stars, etc., as described in, for example, U.S. Pat. No. 7,275,596, US20080196896, which are hereby incorporated herein by reference. In an embodiment, introducing ciliated or coated proppant into the treatment fluid may also stabilize or help stabilize the treatment fluid or regions thereof. Proppant or other particles coated with a hydrophilic polymer can make the particles behave like larger particles and/or more tacky particles in an aqueous medium. The hydrophilic coating on a molecular scale may resemble ciliates, i.e., proppant particulates to which hairlike projections have been attached to or formed on the surfaces thereof. Herein, hydrophilically coated proppant particles are referred to as “ciliated or coated proppant.” Hydrophilically coated proppants and methods of producing them are described, for example, in WO 2011-050046, U.S. Pat. No. 5,905,468, U.S. Pat. No. 8,227,026 and U.S. Pat. No. 8,234,072, which are hereby incorporated herein by reference.

In an embodiment, the particles may be multimodal. As used herein multimodal refers to a plurality of particle sizes or modes which each has a distinct size or particle size distribution, e.g., proppant and fines. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In an embodiment, the particles contain a bimodal mixture of two particles; in an embodiment, the particles contain a trimodal mixture of three particles; in an embodiment, the particles contain a tetramodal mixture of four particles; in an embodiment, the particles contain a pentamodal mixture of five particles, and so on. Representative references disclosing multimodal particle mixtures include U.S. Pat. No. 5,518,996, U.S. Pat. No. 7,784,541, U.S. Pat. No. 7,789,146, U.S. Pat. No. 8,008,234, U.S. Pat. No. 8,119,574, U.S. Pat. No. 8,210,249, US 2010/0300688, US 2012/0000641, US 2012/0138296, US 2012/0132421, US 2012/0111563, WO 2012/054456, US 2012/0305245, US 2012/0305254, US 2012/0132421, PCT/RU2011/000971 and U.S. Ser. No. 13/415,025, each of which are hereby incorporated herein by reference.

“Solids” and “solids volume” refer to all solids present in the slurry, including proppant and subproppant particles, including particle thickeners such as colloids and submicron particles. “Solids-free” and similar terms generally exclude proppant and subproppant particulates, except particle thickeners such as colloids for the purposes of determining the viscosity of a “solids-free” fluid.

“Proppant” refers to particulates that are used in well work-overs and treatments, such as hydraulic fracturing operations, to hold fractures open following the treatment. In some embodiments, the proppant may be of a particle size mode or modes in the slurry having a weight average mean particle size greater than or equal to about 100 microns, e.g., 140 mesh particles correspond to a size of 105 microns. In further embodiments, the proppant may comprise particles or aggregates made from particles with size from 0.001 to 1 mm. All individual values from 0.001 to 1 mm are disclosed and included herein. For example, the solid particulate size may be from a lower limit of 0.001, 0.01, 0.1 or 0.9 mm to an upper limit of 0.009, 0.07, 0.5 or 1 mm. Here particle size is defined is the largest dimension of the grain of said particle.

“Gravel” refers to particles used in gravel packing, and the term is synonymous with proppant as used herein. “Sub-proppant” or “subproppant” refers to particles or particle size or mode (including colloidal and submicron particles) having a smaller size than the proppant mode(s); references to “proppant” exclude subproppant particles and vice versa. In an embodiment, the sub-proppant mode or modes each have a weight average mean particle size less than or equal to about one-half of the weight average mean particle size of a smallest one of the proppant modes, e.g., a suspensive/stabilizing mode.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc. In some embodiments, the proppant of the current application, when present, has a density greater than 2.45 g/mL, e.g., 2.5-2.8 g/mL, such as sand, ceramic, sintered bauxite or resin coated proppant. In some embodiments, the proppant of the current application, when present, has a density greater than or equal to 2.8 g/mL, and/or the treatment fluid may comprise an apparent specific gravity less than 1.5, less than 1.4, less than 1.3, less than 1.2, less than 1.1, or less than 1.05, less than 1, or less than 0.95, for example. In some embodiments a relatively large density difference between the proppant and carrier fluid may enhance proppant settling during the clustering phase, for example.

In some embodiments, the proppant of the current application, when present, has a density less than or equal to 2.45 g/mL, such as lightlultralight proppant from various manufacturers, e.g., hollow proppant. In some embodiments, the treatment fluid comprises an apparent specific gravity greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3. In some embodiments where the proppant may be buoyant, i.e., having a specific gravity less than that of the carrier fluid, the term “settling” shall also be inclusive of upward settling or floating.

Increasing carrier fluid viscosity in a Newtonian fluid proportionally increases the resistance of the carrier fluid motion. In some embodiments, the carrier fluid has a lower limit of apparent dynamic viscosity, determined at 170 s⁻¹ and 25° C., of at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, or at least about 500 mPa-s. A disadvantage of increasing the viscosity is that as the viscosity increases, the friction pressure for pumping the slurry generally increases as well. In this regard, the shear thickening treatment fluid stages and substages may conveniently have a relatively low viscosity in the wellbore for transport to the fracture, but a relatively high viscosity as it flows into and along the fracture where the shear rate is generally higher. In some embodiments, the fluid carrier has an upper limit of apparent dynamic viscosity, determined at 170 s⁻¹ and 25° C., of less than about 1000 mPa-s, or less than about 500 mPa-s, or less than about 300 mPa-s, or less than about 150 mPa-s, or less than about 100 mPa-s, or less than about 50 mPa-s. In an embodiment, the fluid phase viscosity ranges from any lower limit to any higher upper limit.

In some embodiments, an agent may both viscosify and impart yield stress characteristics, and in further embodiments may also function as a friction reducer to reduce friction pressure losses in pumping the treatment fluid. In an embodiment, the liquid phase is essentially free of viscosifier or comprises a viscosifier in an amount ranging from 0.01 up to 12 g/L (0.08-100 ppt) of the fluid phase. The viscosifier can be a viscoelastic surfactant (VES) or a hydratable gelling agent such as a polysaccharide, which may be crosslinked. When using viscosifiers and/or yield stress fluids, proppant settling in some embodiments may be triggered by breaking the fluid using a breaker(s). In some embodiments, the slurry is stabilized for storage and/or pumping or other use at the surface conditions and proppant transport and placement, and settlement triggering is achieved downhole at a later time prior to fracture closure, which may be at a higher temperature, e.g., for some formations, the temperature difference between surface and downhole can be significant and useful for triggering degradation of the viscosifier, any stabilizing particles (e.g., subproppant particles) if present, a yield stress agent or characteristic, and/or a activation of a breaker. Thus in some embodiments, breakers that are either temperature sensitive or time sensitive, either through delayed action breakers or delay in mixing the breaker into the slurry to initiate destabilization of the slurry and/or proppant settling, can be useful.

In embodiments, the fluid may include leakoff control agents, such as, for example, latex dispersions, water soluble polymers, submicron particles, particulates with an aspect ratio higher than 1, or higher than 6, combinations thereof and the like, such as, for example, crosslinked polyvinyl alcohol microgel. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particle fluid loss control agents in the size range of 30 nm to 1 micron, such as y-alumina, colloidal silica, CaCO3, SiO2, bentonite etc.; particulates with different shapes such as glass fibers, flocs, flakes, films; and any combination thereof or the like. Fluid loss agents can if desired also include or be used in combination with acrylamido-methyl-propane sulfonate polymer (AMPS). In an embodiment, the leak-off control agent comprises a reactive solid, e.g., a hydrolyzable material such as PGA, PLA or the like; or it can include a soluble or solubilizable material such as a wax, an oil-soluble resin, or another material soluble in hydrocarbons, or calcium carbonate or another material soluble at low pH; and so on. In an embodiment, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, or the like. The treatment fluid may also contain colloidal particles, such as, for example, colloidal silica, which may function as a loss control agent, gellant and/or thickener.

In embodiments, the proppant-containing treatment fluid may comprise from 0.06 or 0.12 g of proppant per mL of treatment fluid (corresponding to 0.5 or 1 ppa) up to 1.2 or 1.8 g/mL (corresponding to 10 or 15 ppa) or more. In some embodiments, the proppant-laden treatment fluid may have a relatively low proppant loading in earlier-injected fracturing fluid and a relatively higher proppant loading in later-injected fracturing fluid, which may correspond to a relatively narrower fracture width adjacent a tip of the fracture and a relatively wider fracture width adjacent the wellbore. For example, the proppant loading may initially begin at 0.48 g/mL (4 ppa) and be ramped up to 0.6 g/mL (6 ppa) at the end.

Accordingly, the present invention provides the following embodiments:
1. A method for treating a subterranean formation penetrated by a wellbore, comprising:
injecting into the wellbore a shear thickening treatment fluid comprising a slurry of particulates distributed therein;
following the injection into the wellbore, transitioning the shear thickening treatment fluid, from a first flow regime with a relatively moderate shear rate from 10 up to 100 s⁻¹, to a second flow regime with a higher shear rate relative to the moderate shear rate of the first flow regime, wherein the viscosity of the shear thickening treatment fluid increases with increasing shear rate in the second flow regime to inhibit dispersion of the particulates, settling of the particulates or a combination thereof; and
transitioning the shear thickening treatment fluid from the second flow regime to a third flow regime with a lower shear rate relative to the moderate shear rate of the first flow regime, to promote dispersion of at least some of the particulates, settling of at least some of the particulates or a combination thereof.
2. The method of embodiment 1, wherein the particulates comprise proppant and wherein the second and third flow regimes occur in a fracture.
3. The method of embodiment 2, wherein the proppant is heterogeneously placed to form spaced-apart clusters in the fracture, and wherein the method further comprises reducing pressure in the fracture to prop the fracture open on the clusters and form interconnected, hydraulically conductive channels between the clusters.
4. A method to treat a subterranean formation penetrated by a wellbore, comprising:
supplying to the wellbore a treatment stage comprising a plurality of pillar-forming substages alternated between channel-forming substages and including at least one substage comprising a shear thickening treatment fluid;
injecting the treatment stage into the formation above a fracturing pressure to form a fracture;
forming pillars in the fracture spaced apart by channels corresponding to the respective pillar-forming and channel-forming substages;
reducing pressure in the fracture to prop the fracture open on the pillars and form an interconnected, hydraulically conductive network of the channels between the clusters; and
transitioning the shear thickening treatment fluid between a relatively low viscosity flow regime and a high viscosity flow regime.
5. The method of embodiment 4, wherein the transitioning of the shear thickening treatment fluid between the relatively low viscosity flow regime and the high viscosity flow regime comprises increasing a shear rate applied to the shear thickening treatment fluid from less than 100 s⁻¹ in the first flow regime to greater than 100 s⁻¹ in the second flow regime.
6. The method of embodiment 4 or embodiment 5, wherein the pillar-forming substages comprise a proppant-laden treatment fluid and the channel-forming substages comprise a proppant-lean treatment fluid.
7. The method of embodiment 6, wherein the proppant-laden treatment fluid comprises the shear thickening fluid.
8. The method of embodiment 6 or embodiment 7, wherein the proppant-lean treatment fluid comprises the shear thickening fluid.
9. The method of any one of embodiments 4 to 8, further comprising spacer substages between the pillar-forming substages and the channel-forming substages, wherein the spacer stages comprise fiber, the shear thickening treatment fluid, or a combination thereof.
10. A method to treat a subterranean formation penetrated by a wellbore, comprising:
supplying to the wellbore a treatment stage comprising a plurality of proppant-laden substages alternated between proppant-lean substages and including at least one substage comprising a shear thickening treatment fluid;
injecting the treatment stage into the formation above a fracturing pressure to form a fracture;
transitioning the shear thickening treatment fluid, from a first flow regime with a relatively moderate shear rate in the wellbore, to a second flow regime in the fracture with a higher shear rate relative to the moderate shear rate of the first flow regime, wherein the viscosity of the shear thickening treatment fluid increases with increasing shear rate in the second flow regime to inhibit dispersion of the proppant, settling of the proppant or a combination thereof, and to distribute the proppant into the fracture;
transitioning the shear thickening treatment fluid from the second flow regime to a third flow regime in the fracture with a lower shear rate relative to the shear rate of the first flow regime, to promote settling of the proppant from the proppant-laden substage and formation of spaced-apart clusters in the fracture;
reducing pressure in the fracture to prop the fracture open on the clusters and form an interconnected, hydraulically conductive network of channels between the clusters.
11. The method of embodiment 10, wherein the proppant-laden substages comprise the shear thickening fluid.
12. The method of embodiment 10 or embodiment 11, wherein the proppant-lean substages comprise the shear thickening fluid.
13. The method of any one of embodiments 10 to 12, further comprising spacer substages between the proppant-laden substages and the proppant-lean substages, wherein the spacer stages comprise fiber, the shear thickening treatment fluid, or a combination thereof.
14. A system, comprising:
   a subterranean formation penetrated by a wellbore;
   a treatment slurry stage disposed in the wellbore, the treatment slurry stage comprising a plurality of pillar-forming substages alternated between channel-forming substages and including at least one substage comprising a shear thickening treatment fluid; and
   a pump system to continuously deliver the treatment slurry stage from the wellbore to the formation at a pressure above fracturing pressure to inject the treatment fluid stage into a fracture in the formation.
15. The system of embodiment 14, wherein the pillar-forming substages comprise a proppant-laden treatment fluid and the channel-forming substages comprise a proppant-lean treatment fluid.
16. The system of embodiment 14 or embodiment 15, wherein the pillar-forming substages comprise the shear thickening fluid and the channel-forming substages are Newtonian.
17. The system of embodiment 14 or embodiment 15, wherein the channel-forming substages comprise the shear thickening fluid and the proppant-forming substages are Newtonian.
18. The system of any one of embodiments 14 to 17, further comprising spacer substages between the pillar-forming substages and the channel-forming substages, wherein the spacer stages comprise fiber, the shear thickening treatment fluid, or a combination thereof.
19. The system of any one of embodiments 14 to 18, wherein the shear thickening treatment fluid is non-Newtonian over at least a portion of a range of shear rates from 100 s⁻¹ to 1000 s⁻¹.
20. The system of any one of embodiments 14 to 19, further comprising a treatment fluid supply unit to supply the pillar-forming substages and the channel-forming substages to the wellbore.
21. A system to treat a subterranean formation penetrated by a wellbore, comprising:
a pump system to deliver a treatment stage fluid through the wellbore to the formation above a fracturing pressure to form a fracture in the formation;
a treatment stage fluid supply unit to supply the treatment stage fluid to the pump system, the treatment stage fluid comprising a plurality of proppant-laden substages alternated between proppant-lean substages and including at least one substage comprising a shear thickening treatment fluid to inhibit dispersion of the proppant-laden substages, settling of the proppant or a combination thereof, during flow of the shear thickening treatment fluid and facilitate dispersion or settling of the proppant during low-flow conditions;
a shut-in system to terminate delivery of the treatment stage fluid into the fracture, to maintain pressure in the fracture at the low-flow condition to form pillars spaced apart by channels, and to then reduce the pressure in the fracture to prop the fracture open on the pillars and form interconnected, hydraulically conductive network of the channels between the pillars.
22. The system of embodiment 21, wherein the proppant-laden substages comprise the shear thickening fluid and the proppant-lean substages are Newtonian.
23. The system of embodiment 21, wherein the proppant-lean substages comprise the shear thickening fluid and the proppant-laden substages are Newtonian.
24. The system of any one of embodiments 21 to 23, further comprising spacer substages between the proppant-laden substages and the proppant-lean substages, wherein the spacer stages comprise fiber, the shear thickening treatment fluid, or a combination thereof.
25. The system of any one of embodiments 21 to 24, wherein the shear thickening treatment fluid is non-Newtonian over at least a portion of a range of shear rates from 100 s⁻¹ to 1000 s⁻¹.
26. A system to treat a subterranean formation penetrated by a wellbore, comprising:
a treatment stage comprising a plurality of pillar-forming substages alternated between channel-forming substages and including at least one substage comprising a shear thickening treatment fluid;
means for supplying the treatment stage to the wellbore;
means for injecting the treatment stage into the formation above a fracturing pressure to form a fracture;
means for forming pillars in the fracture spaced apart by channels corresponding to the respective pillar-forming and channel-forming substages;
means for reducing pressure in the fracture to prop the fracture open on the pillars and form an interconnected, hydraulically conductive network of the channels between the clusters; and
means for transitioning the shear thickening treatment fluid between a relatively low viscosity flow regime and a high viscosity flow regime.

### EXAMPLES

### Example 1

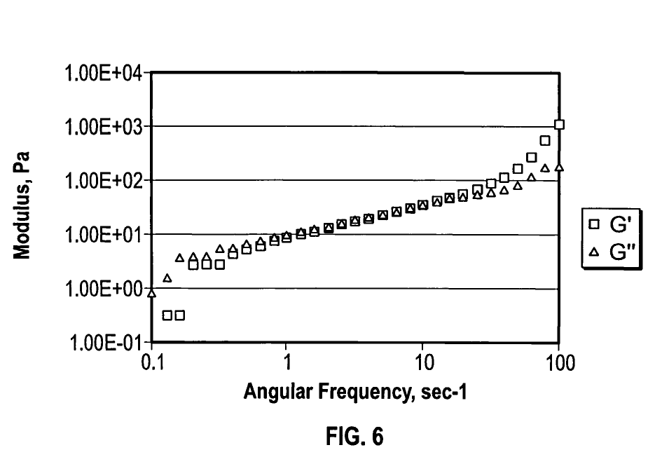

A 20 wt % mixture of pregelatinized starch in deionized water was prepared. Rheological properties were measured using an ANTON PAAR MCR-500 rheometer. The frequency sweep measurement was performed by ramping the angular frequency from 0.1 to 100 s⁻¹ at fixed amplitude equal to 1% of the gap, which was within the linear-viscoelastic range of the prepared starch mixture. The results obtained are shown in FIG. 6. At low angular frequency values the loss modulus (G″) was dominant, indicating a viscous or fluid-like behavior. With the increase of the angular frequency, G″ and storage modulus (G′) became closer, then G′>G″ and finally at high values of frequency the storage modulus, G′, was almost one order of magnitude higher, indicating more solid-like behavior. This G′/G″ behavior was indicative of a fluid with dilatant properties which could be used to carry particulates in the wellbore and/or fracture at a high shear rate and allow the particulates to settle, e.g., to form pillars or clusters, at a low shear rate condition.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method for treating a subterranean formation penetrated by a wellbore, comprising:
injecting into the wellbore a shear thickening treatment fluid comprising a slurry of particulates distributed therein;
following the injection into the wellbore, transitioning the shear thickening treatment fluid, from a first flow regime with a relatively moderate shear rate from 10 up to 100 s⁻¹, to a second flow regime with a higher shear rate relative to the moderate shear rate of the first flow regime, wherein the viscosity of the shear thickening treatment fluid increases with increasing shear rate in the second flow regime to inhibit dispersion of the particulates, settling of the particulates or a combination thereof; and
transitioning the shear thickening treatment fluid from the second flow regime to a third flow regime with a lower shear rate relative to the moderate shear rate of the first flow regime, to promote dispersion of at least some of the particulates, settling of at least some of the particulates or a combination thereof.

2. The method of claim 1, wherein the particulates comprise proppant and wherein the second and third flow regimes occur in a fracture.

3. The method of claim 2, wherein the proppant is heterogeneously placed to form spaced-apart clusters in the fracture, and wherein the method further comprises reducing pressure in the fracture to prop the fracture open on the clusters and form interconnected, hydraulically conductive channels between the clusters.

4. A method to treat a subterranean formation penetrated by a wellbore, comprising:
supplying to the wellbore a treatment stage comprising a plurality of pillar-forming substages alternated between channel-forming substages and including at least one substage comprising a shear thickening treatment fluid;
injecting the treatment stage into the formation above a fracturing pressure to form a fracture;
forming pillars in the fracture spaced apart by channels corresponding to the respective pillar-forming and channel-forming substages;
reducing pressure in the fracture to prop the fracture open on the pillars and form an interconnected, hydraulically conductive network of the channels between the clusters; and
transitioning the shear thickening treatment fluid between a relatively low viscosity flow regime and a high viscosity flow regime.

5. The method of claim 4, wherein the transitioning of the shear thickening treatment fluid between the relatively low viscosity flow regime and the high viscosity flow regime comprises increasing a shear rate applied to the shear thickening treatment fluid from less than 100 s⁻¹ in the first flow regime to greater than 100 s⁻¹ in the second flow regime.

6. The method of claim 4, wherein the pillar-forming substages comprise a proppant-laden treatment fluid and the channel-forming substages comprise a proppant-lean treatment fluid.

7. The method of claim 6, wherein the proppant-laden treatment fluid comprises the shear thickening fluid.

8. The method of claim 6, wherein the proppant-lean treatment fluid comprises the shear thickening fluid.

9. The method of claim 6, further comprising spacer substages between the pillar-forming substages and the channel-forming substages, wherein the spacer stages comprise fiber, the shear thickening treatment fluid, or a combination thereof.

10. A method to treat a subterranean formation penetrated by a wellbore, comprising:
supplying to the wellbore a treatment stage comprising a plurality of proppant-laden substages alternated between proppant-lean substages and including at least one substage comprising a shear thickening treatment fluid;
injecting the treatment stage into the formation above a fracturing pressure to form a fracture;
transitioning the shear thickening treatment fluid, from a first flow regime with a relatively moderate shear rate in the wellbore, to a second flow regime in the fracture with a higher shear rate relative to the moderate shear rate of the first flow regime, wherein the viscosity of the shear thickening treatment fluid increases with increasing shear rate in the second flow regime to inhibit dispersion of the proppant, settling of the proppant or a combination thereof, and to distribute the proppant into the fracture;
transitioning the shear thickening treatment fluid from the second flow regime to a third flow regime in the fracture with a lower shear rate relative to the shear rate of the first flow regime, to promote settling of the proppant from the proppant-laden substage and formation of spaced-apart clusters in the fracture;
reducing pressure in the fracture to prop the fracture open on the clusters and form an interconnected, hydraulically conductive network of channels between the clusters.

11. The method of claim 10, wherein the proppant-laden substages comprise the shear thickening fluid.

12. The method of claim 10, wherein the proppant-lean substages comprise the shear thickening fluid.

13. The method of claim 10, further comprising spacer substages between the proppant-laden substages and the proppant-lean substages, wherein the spacer stages comprise fiber, the shear thickening treatment fluid, or a combination thereof.

14. A system, comprising:
a subterranean formation penetrated by a wellbore;
a treatment slurry stage disposed in the wellbore, the treatment slurry stage comprising a plurality of pillar-forming substages alternated between channel-forming substages and including at least one substage comprising a shear thickening treatment fluid; and
a pump system to continuously deliver the treatment slurry stage from the wellbore to the formation at a pressure above fracturing pressure to inject the treatment fluid stage into a fracture in the formation.

15. The system of claim 14, wherein the pillar-forming substages comprise a proppant-laden treatment fluid and the channel-forming substages comprise a proppant-lean treatment fluid.

16. The system of claim 14, wherein the pillar-forming substages comprise the shear thickening fluid and the channel-forming substages are Newtonian.

17. The system of claim 14, wherein the channel-forming substages comprise the shear thickening fluid and the proppant-forming substages are Newtonian.

18. The system of claim 14, further comprising spacer substages between the pillar-forming substages and the channel-forming substages, wherein the spacer stages comprise fiber, the shear thickening treatment fluid, or a combination thereof.

19. The system of claim 14, wherein the shear thickening treatment fluid is non-Newtonian over at least a portion of a range of shear rates from 100 s⁻¹ to 1000 s⁻¹.

20. The system of claim 14, further comprising a treatment fluid supply unit to supply the pillar-forming substages and the channel-forming substages to the wellbore.

21. A system to treat a subterranean formation penetrated by a wellbore, comprising:
a pump system to deliver a treatment stage fluid through the wellbore to the formation above a fracturing pressure to form a fracture in the formation;
a treatment stage fluid supply unit to supply the treatment stage fluid to the pump system, the treatment stage fluid comprising a plurality of proppant-laden substages alternated between proppant-lean substages and including at least one substage comprising a shear thickening treatment fluid to inhibit dispersion of the proppant-laden substages, settling of the proppant or a combination thereof, during flow of the shear thickening treatment fluid and facilitate dispersion or settling of the proppant during low-flow conditions;
a shut-in system to terminate delivery of the treatment stage fluid into the fracture, to maintain pressure in the fracture at the low-flow condition to form pillars spaced apart by channels, and to then reduce the pressure in the fracture to prop the fracture open on the pillars and form interconnected, hydraulically conductive network of the channels between the pillars.

22. The system of claim 21, wherein the proppant-laden substages comprise the shear thickening fluid and the proppant-lean substages are Newtonian.

23. The system of claim 21, wherein the proppant-lean substages comprise the shear thickening fluid and the proppant-laden substages are Newtonian.

24. The system of claim 21, further comprising spacer substages between the proppant-laden substages and the proppant-lean substages, wherein the spacer stages comprise fiber, the shear thickening treatment fluid, or a combination thereof.

25. The system of claim 21, wherein the shear thickening treatment fluid is non-Newtonian over at least a portion of a range of shear rates from 100 s⁻¹ to 1000 s⁻¹.

26. A system to treat a subterranean formation penetrated by a wellbore, comprising:
a treatment stage comprising a plurality of pillar-forming substages alternated between channel-forming substages and including at least one substage comprising a shear thickening treatment fluid;
means for supplying the treatment stage to the wellbore;
means for injecting the treatment stage into the formation above a fracturing pressure to form a fracture;
means for forming pillars in the fracture spaced apart by channels corresponding to the respective pillar-forming and channel-forming substages;
means for reducing pressure in the fracture to prop the fracture open on the pillars and form an interconnected, hydraulically conductive network of the channels between the clusters; and
means for transitioning the shear thickening treatment fluid between a relatively low viscosity flow regime and a high viscosity flow regime.
